(19) United States
(12) Patent Application Publication
(10) Pub. No.: US 2006/0166548 A1
(43) Pub. Date: Jul. 27, 2006

(54) Electrical connector apparatus, system and method for use with medical devices

(75) Inventors: Robert C. Williams JR., Centerport, NY (US); Ronald Schaller, Canton, GA (US); Steven Hartman, Commack, NY (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: E-Z-EM, Inc.

(21) Appl. No.: 11/387,302

(22) Filed: Mar. 23, 2006

Related U.S. Application Data
(62) Division of application No. 10/391,977, filed on Mar. 19, 2003.

(51) Int. Cl. H01R 11/00

(52) U.S. Cl. 439/502

(57) ABSTRACT

The present invention relates to an electrical connector apparatus, system and method for use with medical devices. In an alternative embodiment, the apparatus of the present invention comprises a first component comprising a first electrical connector adapted to electrically couple with a medical device, and a second component for establishing a connection with an electrical circuit, preferably a microprocessor. The device of the present invention is especially suited for use with medical devices useful in detecting extravasation in an individual undergoing a fluid injection procedure, because it allows for patient mobility, ease of connection and disconnection and more efficient use of medical equipment such as CT scanning equipment.

### CROSS-REFERENCE TO RELATED APPLICATIONS

This application is a divisional application of application Ser. No. 10/391,977, filed Mar. 19, 2003, incorporated herein by reference in its entirety, and claims the benefit of its earlier filing date under 35 U.S.C. 119(e).

### FIELD OF THE INVENTION

The present invention relates to an electrical connector apparatus, system and method for use with medical devices. The present invention is especially suited for use with medical devices useful in detecting the occurrence of extravasation during a fluid injection procedure or IV administration.

### BACKGROUND OF THE INVENTION

Extravasation is the escape, discharge, pouring out or eruption of a fluid from its intended channel or vessel into the individual's surrounding tissue. Extravasation may occur, for example, with the use of an IV catheter. Extravasation may also occur during contrast fluid media injection procedures using power injectors. In those cases, contrast is inadvertently injected into the tissue surrounding the blood vessel, instead of into the blood vessel itself. Although not life-threatening, extravasation causes discomfort to the individual and requires that the procedure be terminated and reinstituted. Complications related to extravasation may be quite severe and may include tissue necrosis. This may require reconstructive surgery to repair.

There exist devices which may be used to detect extravasation in an individual. A device useful for detecting extravasation is currently commercially available under the name “Extravasation Detection Patch” or “EDA Patch” (E-Z-EM, Inc., Lake Success, N.Y.). This device is described in U.S. Pat. No. 5,964,703 to Goodman et al. Similarly, a method for detecting extravasation using an electrode patch is disclosed in U.S. Pat. No. 5,947,910 to Zimmet. Both of these patents are incorporated herein by reference in their entirety.

In one alternative embodiment, an extravasation detection patch is applied to the skin of an individual, contains electrical conductors coated with a hydrogel layer configured to measure skin impedance. A single interconnect cable connects the electrical conductors on the patch to a microprocessor, wherein the microprocessor processes signals from the patch, sets off an alarm if extravasation is detected, and stops a power injector to which it communicates with. The microprocessor may also have a user interface.

Currently, extravasation detection devices such as the EDA patch are affixed to an individual after the catheter for transmitting fluid to the individual has been positioned, for example. Thus, attachment usually takes place in the room where the injection procedure is to take place, such as the CT scanning room. Once affixed to the individual, the extravasation detection device is connected via a single electrical interconnect cable to a microprocessor. The cable simultaneously transmits electricity to the electrodes of the patch and also transmits electrical signals emitted from the electrodes to the microprocessor, which interprets the signals transmitted from the electrodes of the patch.

In practice, connecting the extravasation detection device to a single interconnect cable can be very awkward because the individual is generally lying down on the scanner gantry and the individual's arm is in a bent position during connection. Additionally, the cable may be very long due to the physical characteristics of the room and therefore difficult to handle. This awkwardness makes the connection process very time consuming and can lead to service back-up. Additionally, the connection on the extravasation device can be obstructed and difficult to access, due to an existing IV catheter, dressings, tape, etc., thereby increasing the likelihood of a compromised electrical connection. This could lead to problems in using the extravasation device.

Further, if the individual is undergoing more than one procedure for which extravasation detection is required, such as a CT scanning procedure followed by an IV administration, these procedures will generally be conducted in separate rooms. Thus, using current techniques, the individual must be fitted with multiple extravasation devices and/or the extravasation device must be connected to the microprocessor via the single interconnect cable multiple times.

### SUMMARY OF THE INVENTION

Accordingly, the present invention seeks to remedy the problems of the prior art by providing a convenient, efficient and effective means for electrically connecting a medical device affixed to an individual, such as a device for detecting extravasation, to an electrical circuit. The circuit may contain analog and digital components, for example, wherein the digital components are useful in interpreting feedback from the medical device. Preferably, the electrical circuit includes a microprocessor.

It is therefore an object of the present invention to provide an electrical connector apparatus suitable for use with a medical device, the apparatus having a first component including a first electrical connector adapted to electrically mate with a medical device, the first electrical connector having a means for preventing decoupling of said first electrical connector and said medical device, and a second electrical connector; and a second component comprising an electrical cable having a proximal and a distal end, a third electrical connector located on said distal end of said cable for establishing a connection with an electrical circuit and a fourth electrical connector located on said proximal end of said cable; wherein said second electrical connector is mated with said fourth electrical connector.

In one aspect of the invention, the electrical connector apparatus provided is suitable for use with an extravasation detection device, wherein the extravasation detection device comprises electrical conductors (electrodes). Such an apparatus comprising a first component including a first electrical connector adapted to receive electrical signals from the one or more electrodes of the extravasation detection device, the first electrical connector having a means for preventing decoupling of said first electrical connector and said one or more electrodes, a second electrical connector, and an electrical cable positioned between said first and said second electrical connectors; and a second component including an electrical cable having a proximal and a distal end, a third electrical connector located on said distal end of said cable for establishing an electrical connection with an electrical circuit adapted to receive electrical signals from said one or more electrodes, wherein said electrical circuit includes a microprocessor, and a fourth electrical connector located on said proximal end of said cable; said second electrical connector and said fourth,electrical connector being an interfitting female type cable connector and male type cable connector, respectively, such that when said second electrical connector and said fourth electrical connector are coupled an electrical connection is established.

It is also an object of the present invention to provide an electrical connection system suitable for use with a medical device. In one aspect of the invention, the medical device is used to detect extravasation in an individual undergoing a medical procedure by measuring tissue impedance during the injection procedure.

It is an additional object of the present invention to provide a method for electrically connecting a medical device to an electrical circuit, wherein the medical device is affixed to an individual. In one aspect of the present invention, the method comprises the steps of (i) affixing a medical device for detecting extravasation to an individual undergoing a fluid injection procedure, wherein said medical device includes one or more electrodes; attaching to said medical device a first component including a first electrical connector adapted to receive electrical signals from said one or more electrodes, the first electrical connector having a means for preventing decoupling of said first electrical connector and said one or more electrodes, and a second electrical connector; (ii) attaching to an electrical circuit a second component including an electrical cable having a proximal and a distal end, a third electrical connector located on the distal end of said cable for establishing an electrical connection with said electrical circuit, wherein said electrical circuit is adapted to receive signals from said one or more electrodes, and a fourth electrical connector located on said proximal end of said cable; and, (iii) mating said second electrical connector with said fourth electrical connector, said second electrical connector and said fourth electrical connector being an interfitting female type cable connector and male type cable connector, respectively, such that when said second electrical connector and said fourth electrical connector are coupled an electrical connection is established.

### BRIEF DESCRIPTION OF THE DRAWING(S)

FIG. 1 is a perspective view of an alternative embodiment of the device of the present invention.

FIG. 2 shows a perspective view of a component of the present invention.

FIG. 3 shows a frontal view of an alternative electrical connector of the present invention.

FIG. 4A shows a completed assembly of an alternative embodiment of the present invention.

FIG. 4B shows an assembly of an alternative embodiment of the present invention.

FIG. 5 shows an alternative method of the present invention.

FIG. 6 shows an alternative embodiment of the present invention.

Corresponding reference characters indicate corresponding parts throughout the several views of drawings.

### DETAILED DESCRIPTION OF THE INVENTION

The present invention relates to an electrical connector apparatus, system and method suitable for use with a medical device. The present invention is especially suited for use with medical devices for detecting extravasation during a medical procedure such as a fluid injection procedure. Currently, there exist devices for detecting extravasation, wherein the device is temporarily affixed to an individual undergoing a fluid injection procedure, the device having electrodes which generate electrical signals indicative of tissue impedance. Changes in tissue impedance indicate the occurrence of extravasation. The electrodes are connected via an electrical cable to an electrical circuit adapted to receive and interpret the electrical signals indicative of tissue impedance.

Prior art electrical connectors used to connect a device for detecting extravasation to an electrical circuit/microprocessor include devices affixed to an individual's skin near which are capable of transmitting electrical signals to and from the electrical circuit, wherein the electrical signals represent tissue impedance measurements. The prior art is a long, single interconnect cable. Problems associated with the prior art include difficulty in attaching the single interconnect cable to the extravasation device due to the cable's length, the individual's position, e.g., reclining, and obstructions near the device such as medical tape, such that the electrical connection between the extravasation device and prior art electrical connector is compromised. Further, due to its length, the prior art is often difficult and awkward to attach, thereby resulting in increased individual waiting time and/or procedure time, because the extravasation detection device is generally connected to the electrical circuit in the room where the medical procedure is to take place. Also, if the individual is undergoing multiple procedures which require extravasation detection, once the extravasation device is connected to the single interconnect, then the individual is essentially rendered immnobile, due to length and weight of the singe cable, which may drag alone behind the individual, such that the individual or people may trip on it, or it might tangle or knot. Thus, with prior art devices, a medical device on an individual must be connected and disconnected to an electrical circuit in each procedure room.

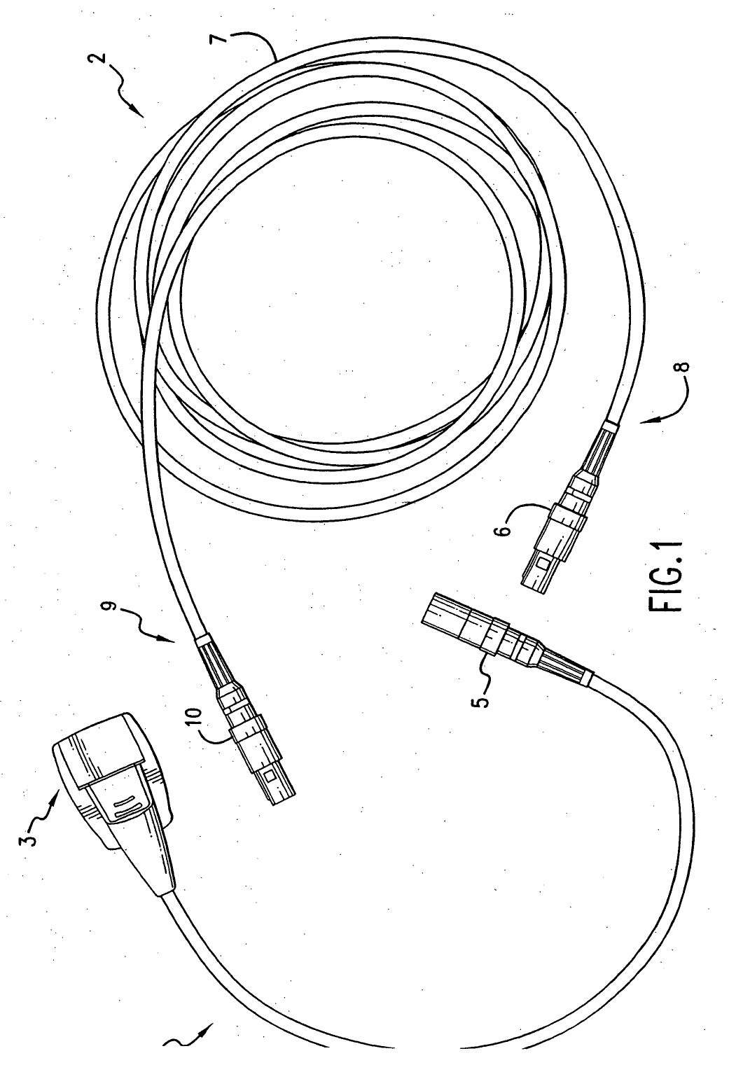

The present invention overcomes these problems by providing an apparatus such as the one shown in FIG. 1, which represents an alternative embodiment of the present invention. Referring to FIG. 1, the electrical connector apparatus of the present invention comprises a first component (1). First component (1) includes electrical connector (3) adapted to establish an electrical connection with a medical device, such as a device for use in detecting extravasation. In certain embodiments herein, electrical connector (3) includes any suitable commercially available low voltage connector including, but not limited to, those manufactured by Alden, LEMO, W W Fischer and others. In other embodiments herein, electrical connector (3) is a male micro DIN connector. In another embodiment, electrical connector (3) is adapted to establish an electrical connection with a medical device having a circular style connector adapted to accept pin contacts, for example.

In a preferred embodiment, electrical connector (3) is capable of establishing a low profile planar electrical interface with electrode elements useful in detecting tissue impedance, wherein the electrodes are part of a medical device for detecting extravasation during a medical procedure. In this manner, electrical connector (3) represents an improvement over the prior art in several ways. For example, it permits the economical manufacture of the extravasation detecting device via automated stack-up and die cutting of constituent materials comprised entirely of laminates, applied gels and applied adhesives. Also, it provides for optimal placement, routing and strain relief of the associated cable relative to the individual when in CT clinical setting.

In a preferred embodiment, electrical connector (3) includes a securing means for engaging and disengaging both physical and electrical connection to a medical device, such as an extravasation device. Securing means suitable for use in the present invention include, but are not limited to, any commercially available locking type mechanism suitable for use with an electrical connector, wherein the mechanism sufficiently prevents decoupling of the connector when mated. In an alternative embodiment, electrical connector (3) is an Alden connector or any other similar type of electrical connector possessing threaded shells that are free to rotate relative to the electrical contacts, thereby facilitating a locking or securing connection to a threaded receptacle on the medical device or electrical circuit. In alternative embodiments, electrical connector (3) is any commercially available locking electrical connectors such as those manufactured by Alden possessing spring loaded shells that partially rotate to create a bayonet style locking interconnect with a receptacle designed to accept the re-entrant or latch geometry of the connector shell. Additionally, commercially available locking electrical connectors such as those manufactured by LEMO, W. W. Fischer and ODU which provide spring loaded keys and flanges to lock the electrical connector with the medical device or electrical circuit are suitable for use herein. Usually, the securing means can be easily and efficiently engaged and disengaged, such that it only requires manipulation by the thumb and index finger of one hand.

Component (1) also includes female cable connector (5) for electrically coupling with male cable connector (6). Male cable connector (6) is located on the distal end (8) of cable (7). Cable (7) also has a proximal end (9). Electrical connector (10) is positioned at the proximal end (9) of cable (7). In one embodiment, electrical connector (10) is a male type electrical connector adapted for electrically connecting cable (7) to an electrical circuit. As used herein, electrical circuit includes, but is not limited to, a wall socket, power strip, battery, generator, microprocessor or any other similar device. In one embodiment, the electrical circuit has both analog and digital components. In a preferred embodiment, the electrical circuit includes a microprocessor. The digital components being useful for providing feedback on the electrical signals received from the medical device. In other embodiments, cable connector (10) is permanently connected to an electrical circuit.

Cables suitable for use herein include one or more strands of insulated electrical conductors laid together, usually around a central core and surrounded by insulation. In preferred embodiments herein, to assure flexibility and longevity of the cable, each conductor is comprised of several strands of copper wire contained in either a poly-vinyl chloride (PVC) or Teflon insulating jacket. The number of conductors used may depend upon the number of discreet signals needed; for example, in the case of the EDA device, four are sufficient. These conductors are bundled together and surrounded by a conductive shield, which may be comprised of a copper or aluminum foil. Alternatively, the shield could be comprised of a woven braid of fine wire. This shielding layer surrounding the bundle of individual signal wires prevents any extraneous electromagnetic energy in the clinical environment from interfering with their signal carrying capability. To keep the bundle of signal wires and their shielding layer in tact in a singular conduit, an outer jacket of PVC or Teflon is extruded over this assembly. Such cables are routinely available from such wire manufacturers as WEICO and Alpha Wire and Cable.

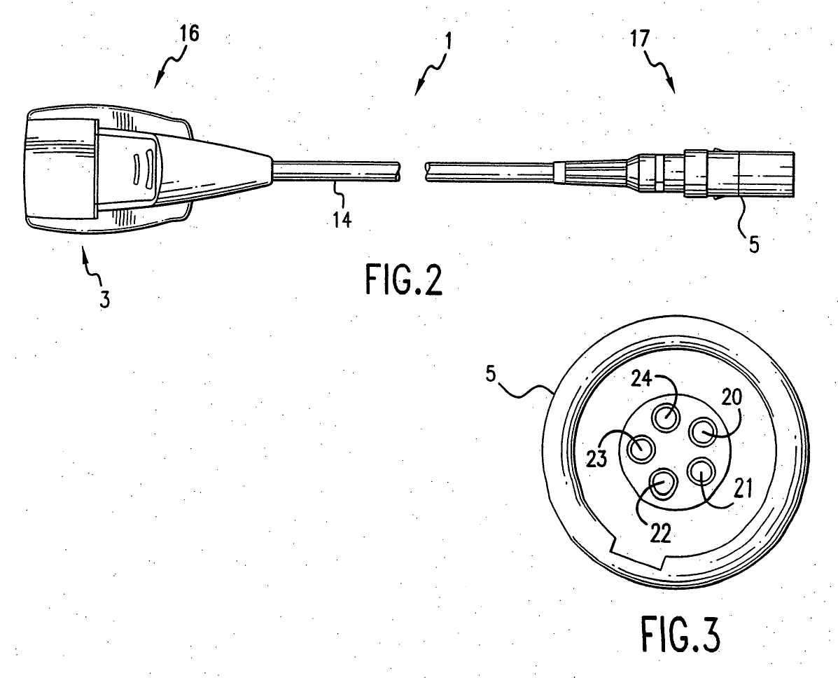

FIG. 2 is a top view of an embodiment of first component (1) of the present invention. In FIG. 2, first component (1) has a proximal end (16) and a distal end (17). First component (1) includes electrical connector (3) located at proximal end (16).

In a preferred embodiment, component (1) is attached to the medical device after the device has been placed on or near an individual, or affixed to the individual. For example, component (1) would be attached after the catheter insertion point is determined and an extravasation detection patch is affixed to skin of the patient near the injection site. Thus, component (1) may be attached to a medical device in a room or place other than where the medical procedure, e.g., injection procedure or scanning procedure is to take place. (See FIG. 5) For example, component (1) may be attached to an extravasation device affixed to an individual while the individual is in a hallway, waiting room or individual preparation room. Further, once component (1) is attached to the medical device, the individual is mobile and may be moved to different procedure rooms without detachment of component (1) from the medical device. Alternatively, component (1) can be attached to a medical device before the device is affixed on or near the individual. Thus, component (1) represents an improvement over the prior art, because it is short and compact, and therefore does not tangle, knot or drag behind the patient, and also does not weigh down the patch such that the patch is dislodged from the skin of the individual.

In one embodiment herein, an individual is to be injected with a contrast agent for a CT abdominal scan, and it is desired that the individual be monitored for extravasation during the injection procedure. In the prior art, the device for detecting extravasation would have to have been connected to an electrical circuit/microprocessor in the CT scanning room via a single cable. However, as shown in FIG. 5, component (1) of the present invention may be attached to an extravasation device in a hallway or waiting room, for example. Thus, when the scanning room is free, the individual can be moved into the scanning room, component (1) quickly connected to component (2), which is connected to an electrical circuit, and the injection/scanning procedure may be performed. Component (1) may then be decoupled from component (2), and the individual may be moved to another room without decoupling of component (1) from the extravasation device. The present invention therefore decreases individual waiting time for a CT scan and increases the efficiency of expensive and limited medical scanning equipment. If a hospital so desires, it may further increase the efficiency of medical equipment such as CT scanning equipment by using multiple connector components (1) on multiple individuals. In that case, if a hospital is performing a CT scan on multiple individuals, each individual may be fitted with a component (1) outside the scanning room, such that when they enter the scanning room their component (1) may be readily attached/detached to a single component (2) inside the scanning room.

In reference to FIG. 2, component (1) may also comprise a length of cable (14). Cable (14) may be of variable length. In one embodiment, the length of cable is about 0.5 inches to about 60 inches, or about 2 to about 40 inches. Preferably, the length of cable is about 20 to about 30 inches, and even more preferably about 24 inches. It has been discovered that this length is optimal for effecting ease of connection of component (1) to a medical device without compromising individual mobility.

Component (1) may also comprise a female type connector (5) located at the distal end (17) of component (1). In one embodiment, female type connector (5) is a female micro-din connector.

FIG. 3 shows a frontal view of female connector (5). In FIG. 3, female connector (5) includes five apertures (20-24) for receiving a male electrical cable connector. In an alternative embodiment, female connector (5) has at least one aperture for receiving a male electrical medical cable connector.

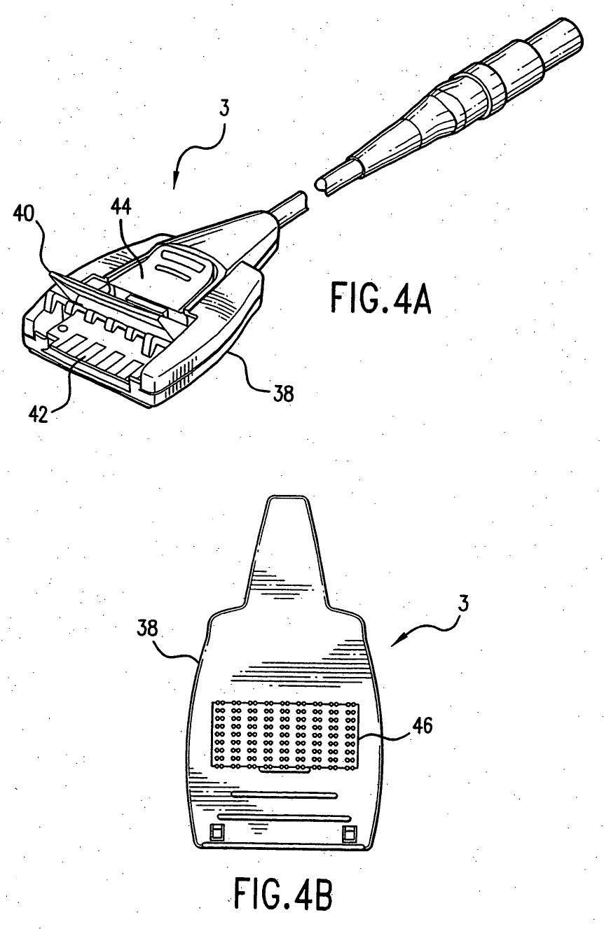

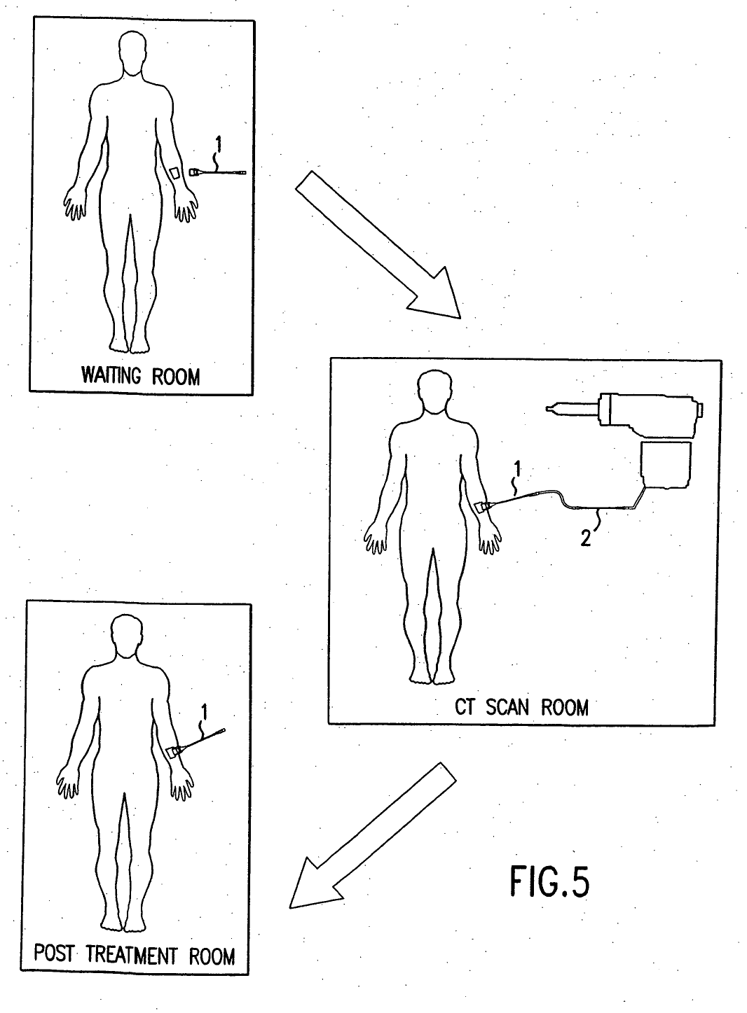

FIGS. 4A and 4B show a preferred embodiment of electrical connector (3) of the present invention. In reference to FIG. 4A, electrical connector (3) consists of an ultrasonically welded plastic connector enclosure (38) that encapsulates a retaining clip (40) for purposes of securing a medical device such as an extravasation device to electrical connector (3). Retaining clip (40) may rotationally open and close within a hinge point incorporated into the design of the connector enclosure (38). Retaining clip (40) closes via direct finger pressure by the user. When closed, the connecting tab of the extravasation device being of laminated construction, for example, is compressed between the retaining clip (40) and electrical contacts (42). The exposed conductive elements of the extravasation device maintain secure planar electrical contact with the electrical contacts (42) belonging to the connector (3) when the retaining clip (40) is closed. Disconnection of the extravasation device from the connector (3) is done so by actuating the releasing button (44) with finger pressure which in turn releases the retaining clip (40) from the closed position. Affixed to the bottom of the connector enclosure, as shown in FIG. 4B, is a self interlocking material (46) such as VELCRO of 3M Dual-Lock material. Interlocking material (46) is used for convenient attachment and detachment of the electrical connector (3) to a securing belt of like material affixed round the peripheral limb of the individual adjacent to an extravasation device also affixed to the individual. Affixing connector (3) to the surface of an individual peripheral limb through the user of an interlocking material (46) supports optimal function between the connector (3) and extravasation device by providing a strain relief between them.

The device of the present invention is suitable for use with an E-Z-EM EDA patch. The EDA patch comprises a layer of hydrogel containing electrodes. Once the EDA patch is affixed to the skin of the individual, an alternating electrical current is applied to a pair of outer electrodes, thereby inducing an electrical current between a pair of inner electrodes. This current is a function of the tissue impedance. Tissue impedance is measured during the injection procedure using the electrical information sensed by the inner pair of electrodes. This electrical information is outputed in the form of a signal received by an electrical circuit/microprocessor containing both analog and digital components. The tissue impedance is monitored throughout the injection procedure by the electrical circuit and changes in the tissue impedance indicate extravasation.

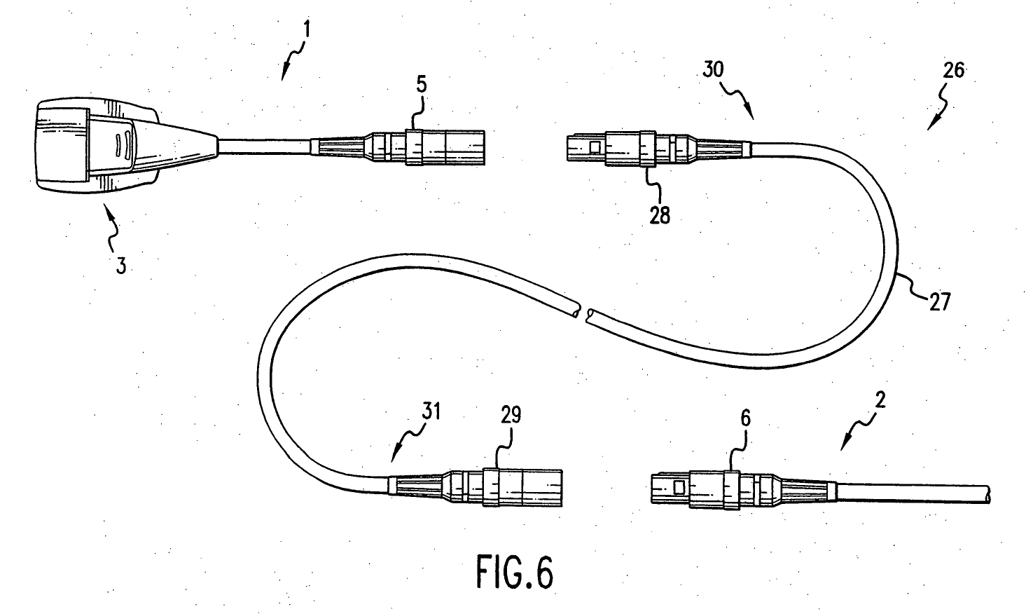

In an alternative embodiment, the device of the present invention comprises one or more electrical cables positioned in line between the first component and the second component of the invention. Such a device may be desirable, for example, if the individual is to be located far away from the electricity supply source, or to accommodate room geometry. Referring to FIG. 6, component (1) and component (2) of the present invention are shown. In one embodiment, the device of the present invention includes component (26), having an electrical cable (27) having a proximal end (30) and distal end (31). In one embodiment, electrical connector (28), located at proximal end (30), is suitable for mating with electrical conductor (5). In one embodiment, electrical connector (28) is a male type cable connector or similar device. Electrical connector (29), located at distal end (31), is suitable for mating with electrical connector (6). In one embodiment, electrical connector (29) is a female type electrical connector or similar device.

### SYSTEM

The present invention also provides an electrical connection system suitable for use with a medical device, wherein the device is useful in detecting extravasation in an individual undergoing a medical procedure. The medical procedure may include, but is not limited to, any fluid injection procedure such as injection via a power injector, IV or infusion pump. For example, the system of the present invention may be used in conjunction with an individual undergoing vascular fluid injection procedure, intravenous (IV) administration of fluid to an individual, or a CT scanning procedure wherein the individual is injected with a contrast agent.

In a preferred embodiment, the system of the present invention includes a medical device useful in detecting extravasation in an individual undergoing a medical procedure, the medical device having one or more electrodes; a first component including a first electrical connector adapted to electrically couple with the medical device, and a second electrical connector; a second component including an electrical cable having a proximal and a distal end, a third electrical connector located on said distal end of said cable for establishing an electrical connection with an electrical circuit and a fourth electrical connector located on said proximal end of said cable; and an electrical circuit; wherein said second electrical connector is adapted to electrically couple with said fourth electrical connector. Further, in the system of the present invention, the first component may include an electrical cable positioned between said first and said second electrical connectors.

As previously noted, the electrical circuit of the present invention may include analog and digital circuit components for interpreting the electrical signals received from the medical device. Preferably, the electrical circuit includes a microprocessor. In an alternative embodiment, the system of the present invention has one or more electrical cables positioned in line between the first component and the second component of the invention. Such an system may be desirable, for example, if the individual is to be located far away from the electricity supply source.

In the system of the present invention, the second and fourth electrical connectors are preferably interfitting male and female type cable connectors. Further, the first electrical connector of the present system may include any suitable commercially available low voltage connector.

### METHOD

The present invention is also directed to a method for electrically connecting a device useful in detecting extravasation in an individual undergoing a medical procedure such as a fluid injection procedure. In a preferred embodiment, the method of the present invention comprises the steps of (1) affixing a medical device for detecting extravasation to a individual undergoing a medical procedure, wherein said medical device includes one or more electrodes; (2) coupling said one or more electrodes with a first electrical connector of a first component, said first electrical connector adapted to receive electrical signals from said one or more electrodes, and said first electrical having a securing means for preventing decoupling of said first electrical connector and said one or more electrodes, and a second electrical connector; (3) coupling a microprocessor with a third electrical connector of a second component, said second component including an electrical cable having a proximal and a distal end, said third electrical connector located on said distal end of said cable for establishing an electrical connection with said microprocessor, wherein said microprocessor is adapted to receive signals from said one or more electrodes, and a fourth electrical connector located on said proximal end of said cable; (4) mating said second electrical connector with said fourth electrical connector, said second electrical connector and said fourth electrical connector being an interfitting female type cable connector and male type cable connector, respectively, such that when said second electrical connector and said fourth electrical connector are mated an electrical connection is established.

In certain embodiments herein, the method of the present invention comprises simultaneously connecting a second individual to a medical device using a second first component while the first individual is connected to the microprocessor component during the procedure. In a preferred embodiment, the method of the present invention comprises the steps of: (1) connecting at least a first and a second medical device to a first and a second individual, respectively, wherein the at least first and second medical devices are useful in detecting extravasation; (2) connecting the at least first medical device to a first component (1) of the present invention; (3) connecting the at least second medical device to a second first component (1) of the present invention; (4) connecting the first component (1) to a component (2) of the present invention; (5) performing a CT scan on the first individual; (6) decoupling said first component (1) from the first component (2); (7) connecting the second component (1) to the component (2) of step 4; performing a CT scan on the second individual; and decoupling the second component (1) from the component (2).

Although particular embodiments of this invention have been described and illustrated herein, the present invention can be further modified within the scope and spirit of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims. Further, the present invention may comprise, consist of or consist essentially of the components or steps disclosed in this specification.

That which is claimed:

1. A method of preparing a first patient for a radiological procedure comprising the steps of:
a. inserting a catheter into a patient while the patient is in a first location;
b. applying an extravasation patch to the patient at the first location;
c. connecting an electrical conduit to the extravasation patch at the first location, wherein the electrical conduit includes a first electrical connector that is removably coupled to the extravasation patch at one end, and a second electrical connector that is capable of being removably coupled to a monitoring device at an opposite end.
d. moving the patient to a second location having a radiological instrument; and
e. connecting the second electrical connector of the electrical conduit to a monitoring device at the second location, wherein the monitoring device and the extravasation patch are in electrical communication with each other so that the monitoring device can process signals measured by the extravasation patch to determine if fluid extravasation occurs, and wherein the electrical conduit and the extending connection facilitate electrical connection between extravasation patch and the monitoring device in the absence of touching, altering or modifying the previously applied extravasation patch.

2. The method according to claim 1, further comprising the steps of:
f. connecting the catheter to a fluid injection device;
g. injecting a fluid into the patient; and
h. measuring tissue impedance near a point at which the catheter is inserted into the patient.

3. The method according to claim 2, further comprising the step of:
i. stopping the injection of the fluid into the patient in the event the monitoring device detects the occurrence of fluid extravasation.

4. The method according to claim 1, further comprising the step of staging one or more patients in a location adjacent to the second location prior to connecting the extravasation patch to the monitoring device.

5. The method according to claim 1, further comprising the step of preparing a second patient for a radiological procedure, comprising the steps of:
i. inserting a second catheter into a second patient at the first location;
ii. applying a second extravasation patch to the second patient;
iii. connecting a second electrical conduit to the extravasation patch;
iv. moving the second patient to the second location having the radiological instrument; and
v. connecting the second electrical conduit to the monitoring device at the second location.

6. The method according to claim 5, wherein the radiological procedure is a CT scanning procedure.

7. The method according to claim 1, wherein the first electrical connector comprises a plurality of electrical contacts, a retaining clip that is moveable between an open and closed position, and a release button that is capable of holding the retaining clip in a closed position, and wherein the plurality of electrical contacts and retaining clip are positioned and arranged so that conductive elements of the extravasation patch are held in electrical contact with the plurality of electrical contacts when the retaining clip is in a closed position.

8. The method according to claim 1, wherein the electrical conduit is about 20 inches to about 30 inches long.

9. A method for electrically connecting a medical device to an individual undergoing a medical procedure comprising the steps of:
a. inserting a channel into an individual while the individual is in a location;
b. applying an extravasation detection device to the individual at the location, the extravasation detection device comprising two or more electrodes;
c. moving the individual from the location to another location having an instrument capable of creating an image of an individual's anatomy;
d. connecting an electrical conduit to an extravasation monitoring device at said another location, the electrical conduit having a first end with a first electrical connector and a second end with an electrical coupler connected to the extravasation monitoring device; and
e. attaching the extravasation detection device to the first electrical connector, the first electrical connector including a retaining clip that is capable of electrically coupling the first electrical connector to the extravasation detection device,
wherein the medical procedure is a procedure capable of creating an image of an individual's anatomy.

10. The method of claim 9, further comprising the step of:
f. preparing a second individual for a procedure capable of creating an image of an individual's anatomy, comprising the steps of:
(A) inserting a second channel into the second individual a location that is different than the said another location;
(B) applying a second extravasation detection device to the second individual;
(C) moving the second individual to said another location; and
(D) connecting the second extravasation detection device to the extravasation monitoring device at said another location.

11. The method of claim 9, wherein the procedure capable of creating an image of an individual's anatomy includes a CT scanning procedure.

12. The method of claim 9, further comprising attaching a first electrical conduit to the extravasation detection device prior to the moving step, and wherein the connecting step comprises attaching a second electrical conduit to the first electrical conduit and the extravasation monitoring device so that signals measured by the extravasation device are communicated to the extravasation monitoring device.

13. The method of claim 9, further comprising attaching a first electrical conduit to the extravasation detection device after the moving step, and wherein the connecting step comprises attaching a second electrical conduit to the first electrical conduit and the extravasation monitoring device so that signals measured by the extravasation device are communicated to the extravasation monitoring device.

14. The method of claim 9, wherein the attaching step is before the connecting step.

15. The method of claim 9, wherein the attaching step is after the connecting step.

16. The method of claim 9, wherein the channel is a catheter.

17. A method for detecting extravasation in two or more individuals, the method comprising the steps of:
(a) inserting a first channel into a first individual at a location
(b) applying a first extravasation detection device to the first individual at the location;
(c) moving the first individual to another location having an instrument capable of creating an image of an individual's anatomy;
(d) connecting the first extravasation detection device to a monitoring device at said another location;
(e) inserting a second channel into a second individual;
(f) applying a second extravasation detection device to the second individual;
(g) moving the second individual to said another location having an instrument capable of creating an image of an individual's anatomy; and
(h) connecting the second extravasation detection device to a monitoring device at said another location. wherein the first extravasation detection device and wherein the connecting steps each comprise connecting an electrical conduit to the monitoring device, the electrical conduits each including a first end having a first electrical connector and a second end having an electrical coupler that is connectable to the monitoring device, and wherein each of the first electrical connectors includes a retaining clip that is capable of electrically coupling the first electrical connector to each respective extravasation detection device.

18. The method according to claim 17, wherein each electrical connector comprises a plurality of electrical contacts, a retaining clip that is moveable between an open and closed position, and a release button that is capable of holding the retaining clip in a closed position, and wherein the plurality of electrical contacts and retaining clip are positioned and arranged so that conductive elements of the first device are held in electrical contact with the plurality of electrical contacts when the retaining clip is in a closed position.

19. The method of claim 18, wherein the procedure capable of creating an image of an individual's anatomy is a CT scanner.

20. The method of claim 18, wherein at least one of the first channel and the second channel is a catheter.

21. A method of performing multiple fluid injections on a patient comprising the steps of:
a. inserting a catheter into a patient while the patient is at a first location;
b. applying an extravasation patch to the patient at the first location;
c. moving the patient to a second location having an instrument capable of creating an image of an individual's anatomy;
d. connecting the extravasation patch to an extravasation monitoring device at the second location, wherein the monitoring device and the extravasation patch are in electrical communication with each other so that the monitoring device can process signals measured by the extravasation patch to determine if fluid extravasation occurs;
e. connecting the catheter to a fluid injection device;
f. injecting a fluid into the patient;
g. measuring tissue impedance near a point at which the catheter is inserted into the patient;
h. disconnecting the extravasation device from the extravasation monitoring device;
i. imaging a portion of the patient's anatomy;
j. moving the patient to another location having an instrument capable of creating an image of an individual's anatomy; and
k. repeating steps d) through i) to image two or more additional portions of the patient's anatomy.

22. The method of claim 21, further comprising the step of:
stopping the injection of the fluid into the patient in the event the monitoring device detects the occurrence of fluid extravasation.

23. The method according to claim 21, further comprising the step of connecting an electrical conduit to the extravasation after moving the patient to a second location, wherein the electrical conduit comprises a first electrical connector that is removably coupled to the extravasation patch at one end, and a second electrical connector that is removably coupled to the extravasation monitoring device at an opposite end.

24. The method according to claim 21, wherein the first electrical connector comprises a plurality of electrical contacts, a retaining clip that is moveable between an open and closed position, and a release button that is capable of holding the retaining clip in a closed position, and wherein the plurality of electrical contacts and retaining clip are positioned and arranged so that conductive elements of the extravasation patch are held in electrical contact with the plurality of electrical contacts when the retaining clip is in a closed position.

25. The method according to claim 21, wherein the electrical conduit is about 20 inches to about 30 inches long.

26. A method of staging two or more patients that are to undergo a medical imaging procedure, the method comprising:
a. inserting a catheter into a patient while the patient is at a first location;
b. applying an extravasation patch to the patient at the first location;
c. moving the patient into a staging location until the patient is ready to undergo a medical imaging procedure;
d. moving the patient into another location having an instrument capable of creating an image of an individual's anatomy; and
d. connecting the extravasation patch to an extravasation monitoring device at the second location, wherein the monitoring device and the extravasation patch are in electrical communication with each other so that the monitoring device can process signals measured by the extravasation patch to determine if fluid extravasation occurs.

27. The method of claim 26, wherein two or more patients are positioned in the staging location prior to undergoing the medical imaging procedure, and wherein a catheter has been inserted into each patient and an extravasation device has been applied to each patient.

28. The method of claim 26, wherein a second patient is undergoing a medical imaging procedure at said another location, and said method further comprises moving the patient from said staging location into said another location after the second patient has completed the medical imaging procedure.
